(19) United States
(12) Patent Application Publication
(10) Pub. No.: US 2010/0075083 A1
(43) Pub. Date: Mar. 25, 2010

(54) Process for In-Mold Application of Metal Finish Coating

(75) Inventor: Kenneth A. Harbaugh, Villa Rica, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Southern Sales & Marketing Group, Inc., Atlanta, GA (US)

(21) Appl. No.: 12/236,087

(22) Filed: Sep. 23, 2008

(51) Int. Cl. B32B 15/09; B29C 43/20

(52) U.S. Cl. 428/35.8; 156/245

(57) ABSTRACT

A process for manufacturing a fiberglass planter having a metal finish on its exterior surface includes the step of inserting a flexible mold into a hard mold. The flexible mold has an outer surface that fits the inner surface of the hard mold, and the flexible mold has an inner surface which defines a cavity for forming a planter. A layer of a metal powder is applied onto the inner surface of the flexible mold. A layer of polyester resin is then applied onto the metal powder layer formed on the flexible mold inner surface. Next, a fiberglass planter is formed on the polyester resin layer by applying alternating layers of polyester resin and fiberglass cloth and ending with an innermost layer of polyester resin. The layer of metal powder, the layer of polyester resin on the metal powder layer, and the fiberglass planter comprise a metal coated fiberglass planter. The flexible mold and the metal coated fiberglass planter are then separated from the hard mold, and the flexible mold is separated from the metal coated fiberglass planter.

### TECHNICAL FIELD

The present invention relates to a process of manufacturing fiberglass planters. More specifically, the invention relates to a process for manufacturing a fiberglass planter with a metal finish on its exterior surface, wherein the metal finish is applied as a part of a molding process.

### BACKGROUND OF THE INVENTION

Fiberglass planters are commonly coated for decorative reasons, for durability, or for other purposes. The coating should be capable of withstanding a variety of weather conditions. Generally the coating is imparted to the outer surface of the planter by applying layers of paint. Existing fiberglass planter manufacturing processes typically apply the coating after the planter has been molded. Thus when the planter is turned out of its mold, the planter has to be chemically washed and then rinsed so that a primer will properly adhere to its surface. After the chemical washing step, the primer is applied, then the main paint layer. All the coating (painting) steps are done “out of mold.”

One problem encountered during planter coating is that each coat typically needs to be applied to the planter surface in a separate operation after the molding of the planter in the silicone mold. Each of these steps is time consuming. In addition, this conventional coating method cannot provide a real metal finish effect.

Thus there is a need for a process of coating a planter that reduces the amount of necessary steps.

There is a further need for a fiberglass planer having a more durable and realistic metallic finish coating.

### SUMMARY OF THE INVENTION

Stated generally, the present invention comprises a process for manufacturing a fiberglass planter having a metal finish on its exterior surface. A flexible mold is inserted into a hard mold. The flexible mold has an outer surface that fits the inner surface of the hard mold, and the flexible mold has an inner surface which defines a cavity for forming a planter. A layer of a metal powder is applied onto the inner surface of the flexible mold. A layer of polyester resin is then applied onto the metal powder layer formed on the flexible mold inner surface. Next, a fiberglass planter is formed on the polyester resin layer by applying alternating layers of polyester resin and fiberglass cloth and ending with an innermost layer of polyester resin. The layer of metal powder, the layer of polyester resin on the metal powder layer, and the fiberglass planter comprise a metal coated fiberglass planter. The flexible mold and the metal coated fiberglass planter are then separated from the hard mold, and the flexible mold is separated from the metal coated fiberglass planter.

Optionally the hard mold is rotatably mounted about its axis of symmetry, and the mold is rotated by the artisan to facilitate the manufacturing process.

In a disclosed embodiment, the layer of metal powder comprises particles ranging in size from −600 to +800 Mesh, and the layer is less than 1 millimeter in thickness. Examples of suitable metals include, but are not limited to, copper, steel, and iron.

Thus it is an object of the present invention to provide an improved process for manufacturing a fiberglass planter having a metal finish on its exterior surface.

It is another object of the present invention to provide a process for manufacturing a finished fiberglass planter that does not require chemical washing and spraying, thus offering safety and environmental benefits.

It is a further object of the present invention to provide a process for manufacturing a finished fiberglass planter that requires fewer steps.

Other objects, features, and advantages of the present invention will become apparent upon reading the following specification, when taken in conjunction with the drawings and the appended claims.

### BRIEF DESCRIPTION OF THE DRAWINGS

FIG. 1 is a cross-sectional view of a first step in a process for manufacturing a metal coated planter, in which a flexible mold is inserted into a hard mold.

FIG. 2 is a cross-sectional view of a second step in the process of FIG. 1, in which a metal powder layer is applied to the interior surfaces of the flexible mold.

FIG. 3 is a cross-sectional view of a third step in the process of FIG. 1, in which a layer of resin is formed over the layer of metal.

FIG. 4 is a cross-sectional view of a fourth step in the process of FIG. 1, in which a fiberglass planter is built up over the layer of resin that covers the metal layer.

FIG. 5 is a cross-sectional view of a fifth step in the process of FIG. 1, in which the flexible mold and its contents are removed from the hard mold.

FIG. 6 is a cross-sectional view of a sixth step in the process of FIG. 1, in which the flexible mold is stripped from the metal coated fiberglass planter.

FIG. 7 is an isometric view of the metal coated fiberglass planter manufactured according to the process of FIGS. 1-6.

FIG. 8 is an isometric view of a stand for holding a hard mold for performing the process of FIGS. 1-7, showing the hard mold in a first position.

FIG. 9 is an isometric view of the stand of FIG. 8, showing the hard mold in a second position.

### DETAILED DESCRIPTION OF THE DISCLOSED EMBODIMENT

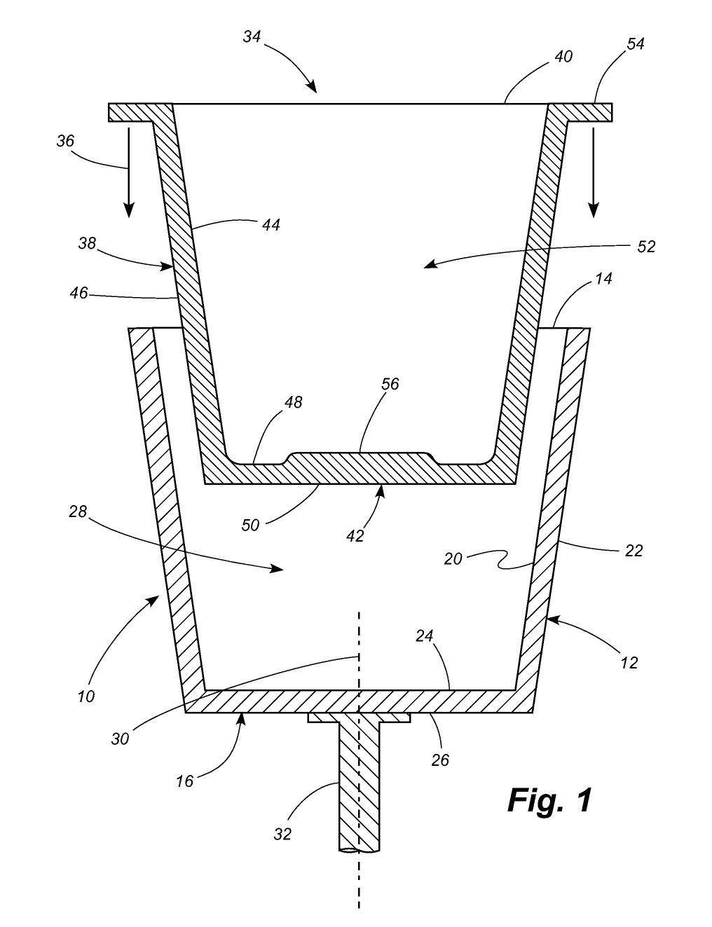

Referring now to the drawings, in which like numerals indicate like elements throughout the several views, FIG. 1 depicts a hard mold 10. As used herein, the term “hard mold” means that the mold will maintain its shape and resist breaking or deforming when subjected to stresses of a magnitude normally encountered during the disclosed manufacturing process. The hard mold 10 is frustoconical, with an angled side wall 12, an open upper end 14, and a base 16 having a diameter smaller than the upper end 14. The side wall 12 has an interior surface 20 and an exterior surface 22. Likewise, the base 16 has an interior surface 24 and an exterior surface 26. The interior surfaces 20, 24 of the side wall 12 and base 16 define a cavity 28. The hard mold 10 has an axis of symmetry indicated by the dashed line 30. Extending outward from the exterior surface 26 of the base 16 and aligned with the axis of symmetry 30 is a shaft 32.

With further reference to FIG. 1, a flexible mold 34 comprised of, e.g., silicone is illustrated being inserted into the open upper end 14 of the hard mold 10 in the direction indicated by the arrows 36. The flexible mold 34 is substantially flexible and may be substantially deformed without damaging it. The flexible mold 34 is frustoconical, with an angled side wall 38, an open upper end 40, and a base 42 having a diameter smaller than the upper end 40. The side wall 38 has an interior surface 44 and an exterior surface 46. Likewise, the base 42 has an interior surface 48 and an exterior surface 50. The exterior surfaces 46, 50 of the base 42 and side wall 38, respectively, are shaped to fit the cavity 28 of the hard mold 10. The interior surfaces 44, 48 of the side wall 38 and base 42 define a cavity 52 within which a planter is formed. A peripheral flange 54 extends radially outward from the upper end 40 of the flexible mold 34. A short, generally frustoconical protrusion 56 extends upward from the center of the interior surface 48 of the base 42.

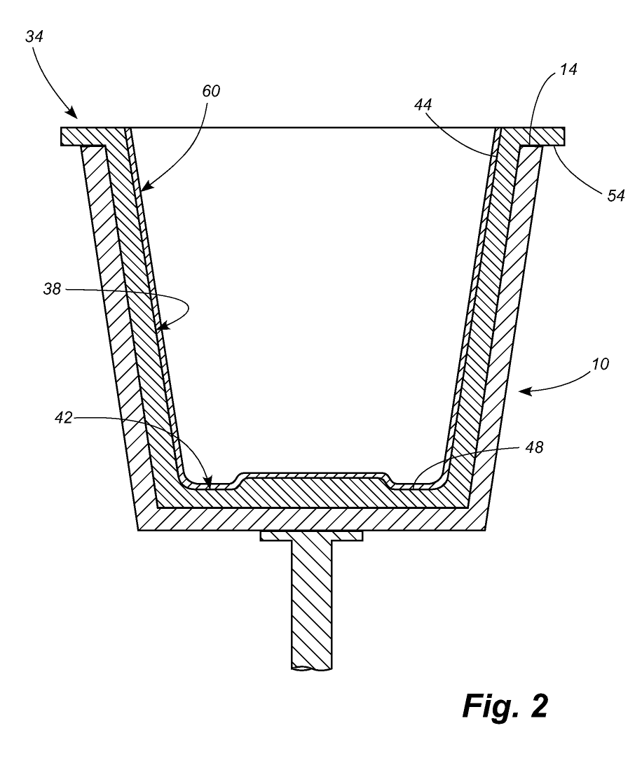

In FIG. 2, the flexible mold 34 is completely seated within the cavity 28 (FIG. 1) of the hard mold 10. The peripheral flange 54 of the flexible mold 34 is imposed against the upper end 14 of the hard mold 10. A layer 60 of metal powder is built up on the interior surfaces 44, 48 of the side wall 38 and base 42 of the flexible mold 34.

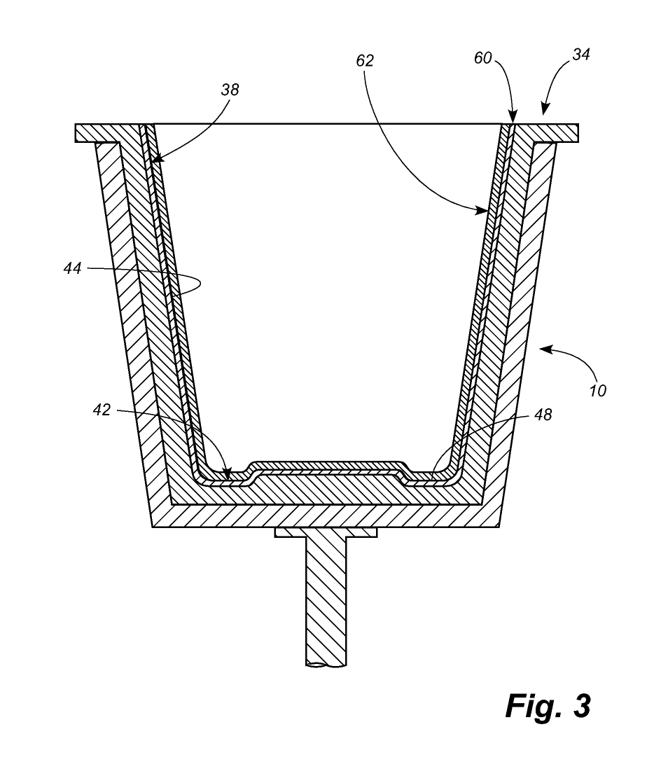

Once the layer 60 of metal powder has been built up on the interior surfaces 44, 48 of the side wall 38 and base 42 of the flexible mold 34, a layer 62 of resin is applied over the metal layer 60, as shown in FIG. 3. In the disclosed embodiment the resin is a polyester resin, more specifically, an unsaturated polyester resin in the form of euplastic liquid. However, the specific resin is disclosed only by way of example, and other suitable resins can be used.

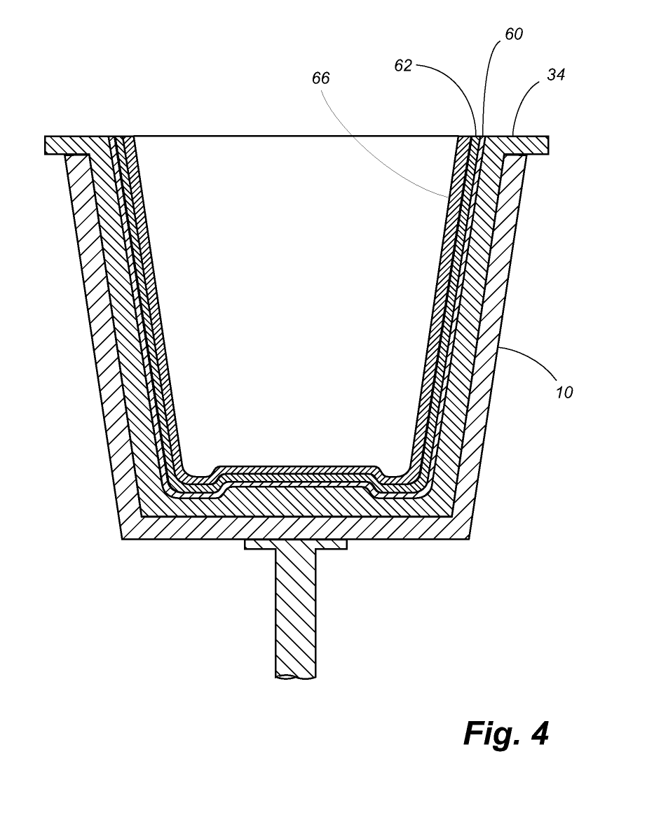

Referring now to FIG. 4, after the layer 62 of resin is applied over the layer 60 of metal powder, a fiberglass planter 66 is formed on the resin layer 62 by applying alternating layers of resin and fiberglass and ending with an innermost layer of resin. This build up can occur in a variety of ways. Before the layer 62 of resin has cured, fiberglass, such as fiberglass fabric cut into strips, is applied over the layer 62. Then another layer of resin is applied over the first layer of fiberglass strips, followed by a second layer of fiberglass strips. As many layers of fiberglass and resin can be used as may be required to provide the desired strength and durability. Alternatively, rather than immediately applying the fiberglass to the layer 62 of resin, the layer 62 of resin can be permitted to cure. Then a new layer of resin is formed on the layer 62, followed by alternating layers of fiberglass and resin and ending with an innermost layer of resin.

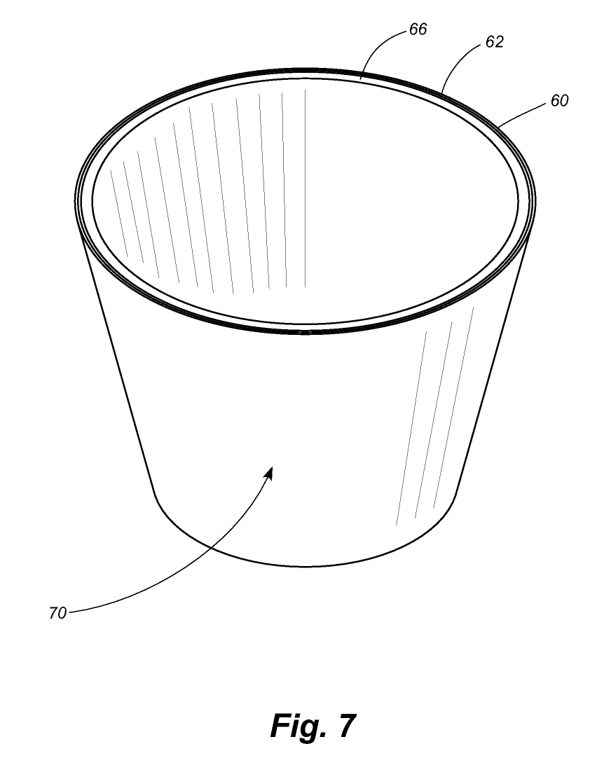

For convenience of description, the layer 60 of metal, the layer 62 of resin, and the fiberglass planter 66 will together be referred to as a metal coated fiberglass planter 70 (FIG. 7).

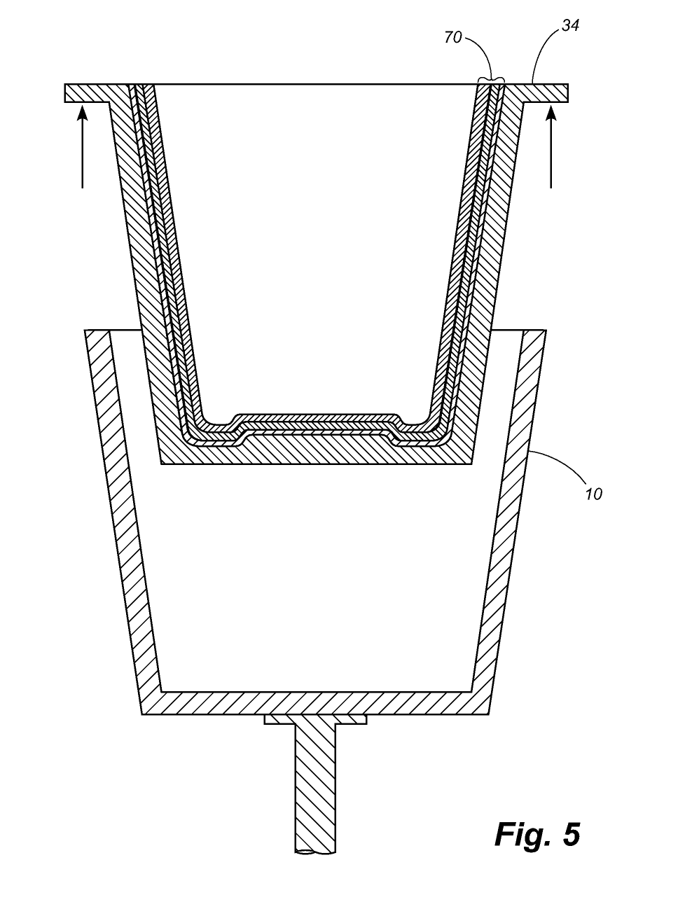

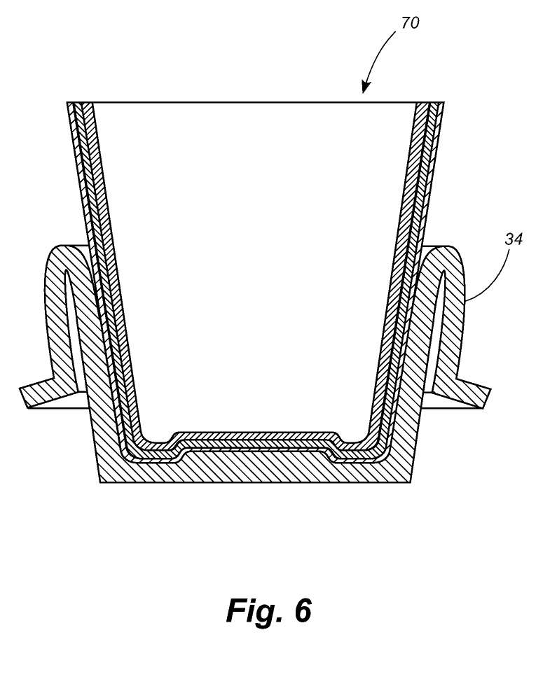

After the fiberglass planter 66 has cured, the flexible mold 34 is removed from the hard mold 10, as shown in FIG. 5. The flexible mold 34 is then stripped from the metal coated fiberglass planter 70, as shown in FIG. 6. The flexible mold 34 can be stripped as a single piece and reused.

After the flexible mold has been stripped from the metal coated fiberglass planter 70, as shown in FIG. 7, the exterior surface of the planter can be polished, such as by a motorized abrasive cloth. Then, if desired, an antioxidant can be applied to the polished metal surface to maintain the finish.

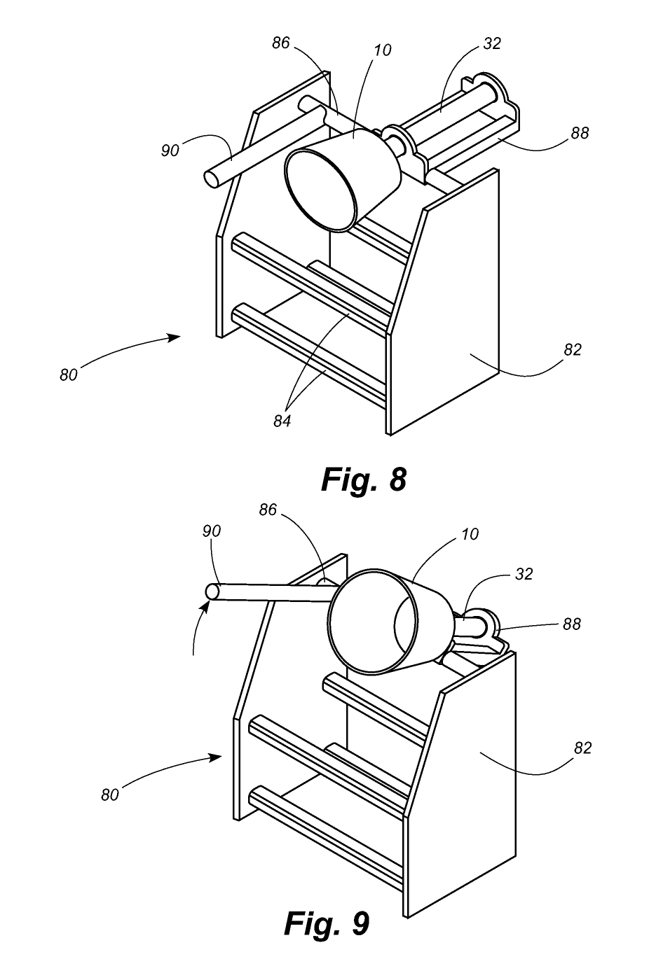

FIGS. 8 and 9 illustrate an optional apparatus in the form of a stand 80 to facilitate the process described above. The stand 80 comprises end panels 82 and cross bracing 84. A pipe 86 is rotatably mounted between the end panels 82. A mount 88 is mounted to the pipe 86 and has provisions for receiving the shaft 32 of the hard mold 10 for rotary movement. Bearings may be provided where the pipe 86 is mounted to each end panel 82 and where the shaft 32 engages the mount 88. The hard mold 10 can be either manually rotated about its axis of symmetry 30 (FIG. 1) or rotated by an electric motor. For example, a 0.8-1 hp electric motor can be arranged to rotate the hard mold at about 70 rpm. A handle 90 extends radially from the pipe 86 and can be used to rotate the pipe and thereby control the angle of orientation of the hard mold 10.

When the steps of spreading the metal powder and resin into the inner surfaces 44, 48 of the flexible mold 34 are being performed (see FIGS. 2, 3), the pipe 86 can be arranged such that the shaft 32 of the hard mold 10 is substantially horizontal, as depicted in FIG. 8. Thus the metal powder and resin can spread evenly over the entire depth of the flexible mold 34. At the preference of the worker, the axis of symmetry 30 of the hard mold 10 can be set in more of a vertical direction, as shown in FIG. 9, to form the layers into the bottom portion of the flexible mold 34. The worker can then set the axis 30 of the hard mold 10 closer to horizontal to form the layers into the near-rim portion of the flexible mold 34. When the flexible mold 34 is being loaded into or removed from the hard mold 10, the axis 30 of the hard mold is set at an angle for convenient operation. Setting the angle of the axis 30 of the hard mold 10 is done by rotating the handle 90 and locking the pipe 86 at that angle.

In the disclosed embodiment, the layer 60 of metal powder is less than one millimeter thick and is comprised of metal particles ranging in size, for example, from −600 to +800 mesh. Also in the disclosed embodiment, the metal powder is a mixture of primarily copper, with small amounts of iron and steel. However, other metals may be employed, depending upon the color, aesthetic appearance, and physical characteristics desired. Likewise, the one millimeter thickness of the metal powder layer 60 is only an example, and a metal powder layer of greater or lesser thickness can be employed. The primary determinant is that the metal powder layer 60 be thick enough to completely cover the exterior surface of the finished planter and that it be robust enough to withstand polishing without wearing away and revealing bare resin/fiberglass underneath.

Similarly, the resin layer 62 formed on the metal powder layer 60 is disclosed as being approximately 1 millimeter thick. However, this thickness is not crucial and is disclosed only by way of example. The important factor is that the resin layer 62 be sufficiently thick to completely cover the metal powder layer 60 and to bond the metal satisfactorily to the underlying fiberglass planter.

Finally, it will be understood that the preferred embodiment has been disclosed by way of example, and that other modifications may occur to those skilled in the art without departing from the scope and spirit of the appended claims.

What is claimed is:

1. A process for manufacturing a fiberglass planter, comprising the steps of:
inserting a flexible mold into a hard mold, the flexible mold having an outer surface which fits the inner surface of the hard mold, and the flexible mold having an inner surface which defines a cavity for forming a planter;
applying a layer of a metal powder onto the flexible mold inner surface;
applying a layer of resin onto the metal powder layer on the flexible mold inner surface;
forming a fiberglass planter on the resin layer by applying alternating layers of resin and fiberglass cloth and ending with an innermost layer of resin, wherein the layer of metal powder, the layer of resin on the metal powder layer, and the fiberglass planter comprise a metal coated fiberglass planter;
separating the flexible mold and the metal coated fiberglass planter from the hard mold; and
separating the flexible mold from the metal coated fiberglass planter.

2. The process of claim 1, wherein the step of inserting a flexible mold into a hard mold comprises the step of inserting a flexible mold into a hard mold having an axis of symmetry, the hard mold being rotatable about the axis of symmetry.

3. The process of claim 1, further comprising the step, subsequent to said step of separating the flexible mold from the metal coated fiberglass planter, of polishing the metal powder layer.

4. The process of claim 3, further comprising the step, subsequent to said step of polishing the metal powder layer, of applying anti-oxidant to the polished metal powder layer.

5. The process of claim 1, further comprising the step, prior to said step of applying a layer of a metal powder onto the flexible mold inner surface, of milling a metal into powder shape in the presence of heat to form the metal powder.

6. The process of claim 5, wherein the step of milling a metal into powder shape in the presence of heat comprises the step of milling a metal into powder shape in the presence of heat of approximately 1,500° C.

7. The process of claim 1, wherein the step of applying a layer of a metal powder onto the flexible mold inner surface comprises the step of applying a layer of powder comprising primarily copper, with smaller amounts of steel and iron intermixed.

8. The process of claim 1 wherein the step of applying a layer of a metal powder onto the flexible mold inner surface comprises the step of applying a layer of metal powder having particles ranging in size from −600 to +800 Mesh.

9. The process of claim 1 wherein the step of applying a layer of a metal powder onto the flexible mold inner surface comprises the step of applying a layer having a thickness of less than 1 millimeter of a metal powder onto the flexible mold inner surface.

10. The process of claim 1 wherein the step of applying a layer of resin onto the metal powder layer comprises the step of applying a layer of polyester resin onto the metal powder layer.

11. The process of claim 10 wherein the step of applying a layer of polyester resin onto the metal powder layer comprises the step of applying a layer of unsaturated polyester resin onto the metal powder layer.

12. The process of claim 11, wherein the step of applying a layer of unsaturated polyester resin onto the metal powder layer comprises the step of applying a layer of unsaturated polyester resin in the form of euplastic liquid onto the metal powder layer.

13. The process of claim 1, wherein the step of applying a layer of resin onto the metal powder layer comprises the step of applying a layer of resin having a thickness of approximately 1 millimeter onto the metal powder layer.

14. The process of claim 2, comprising the further step of rotating the hard mold during at least portions of the steps of applying the layer of a metal powder, applying the layer of resin onto the metal powder layer, and forming a fiberglass planter.

15. The process of claim 1 wherein the step of separating the flexible mold from the metal coated fiberglass planter includes the step of peeling the flexible mold away from the metal coated fiberglass planter in a single piece;

16. The process of claim 3, wherein the step of polishing the metal powder layer comprises the step of polishing the metal powder layer using a motorized abrasive cloth.

17. The process of claim 1, wherein the step of inserting a flexible mold into a hard mold comprises the step of inserting a silicone mold into the hard mold.

18. An article of manufacture, comprising:
a fiberglass planter having an exterior surface;
a layer of resin disposed on the exterior surface of the fiberglass planter;
a layer of metal powder bonded to the exterior surface of the fiberglass planter by the layer of resin, the fiberglass planter, the layer of metal, and the layer of resin bonding the layer of metal to the fiberglass planter comprising a coated planter; and
a flexible mold having an interior surface intimately surrounding the coated planter.

19. The article of manufacture of claim 18, wherein the flexible mold has an outer surface, and wherein the article of manufacture further comprises a hard mold having an inner surface intimately surrounding the outer surface of the flexible mold.
